(19) United States
(12) Patent Application Publication
(10) Pub. No.: US 2026/0299489 A1
(43) Pub. Date: Oct. 1, 2026

(54) CONVEYANCE APPARATUS

(71) Applicant: CANON KABUSHIKI KAISHA, Tokyo (JP)

(72) Inventor: KAZUYA MOROHASHI, Shizuoka (JP)

(21) Appl. No.: 19/630,260

(22) Filed: Mar. 26, 2026

(30) Foreign Application Priority Data
Mar. 27, 2025 (JP) 2025-052827

(51) Int. Cl. G03G 15/00; G01D 5/347

(52) U.S. Cl. CPC G03G 15/6511; G01D 5/34707; G01D 5/3473; G03G 2215/00687

(57) ABSTRACT

A conveyance apparatus includes a motor, a gear, a first side plate configured to support the gear, a second side plate that is disposed inside the conveyance apparatus relative to the first side plate in a rotation axis direction of the gear, a detected portion that is connected to the gear and configured to rotate together with the gear, and a sensor, wherein, in the rotation axis direction, teeth of the gear are located between the first side plate and the second side plate, wherein, in a case where a direction from the first side plate toward the second side plate in the rotation axis direction is defined as a first direction, the detected portion is located upstream of the first side plate in the first direction, and wherein at least a part of the motor is located downstream of the detected portion in the first direction.

### BACKGROUND

### Field of the Technology

The present disclosure relates to a conveyance apparatus that conveys a recording medium.

### Description of the Related Art

An image forming apparatus described in Japanese Patent Laid-Open No. 2011-190922 includes a motor, a transmission unit that transmits a driving force of the motor, a detected portion that receives the driving force from the transmission unit and rotates, a detection unit that detects rotation of the detected portion, and a side plate that is disposed outside the transmission unit. Further, the detected portion is located outside the side plate, and the motor is located outside the detected portion.

In the image forming apparatus described in Japanese Patent Laid-Open No. 2011-190922, the motor is disposed outside the detected portion, and a space inside the detected portion cannot be utilized as a space for arranging the motor.

### SUMMARY

Accordingly, the present disclosure is directed to utilizing a space inside a detected portion as a space for arranging a motor.

According to an aspect of the present disclosure, a conveyance apparatus that conveys a recording medium includes a motor configured to generate a driving force, a gear configured to rotate by receiving the driving force, a first side plate configured to support the gear, a second side plate that is disposed inside the conveyance apparatus relative to the first side plate in a rotation axis direction of the gear and configured to support the gear, a detected portion that is connected to the gear and configured to rotate together with the gear, and a sensor configured to detect rotation of the detected portion, wherein, in the rotation axis direction, teeth of the gear are located between the first side plate and the second side plate, wherein, in a case where a direction from the first side plate toward the second side plate in the rotation axis direction is defined as a first direction, the detected portion is located upstream of the first side plate in the first direction, and wherein at least a part of the motor is located downstream of the detected portion in the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system according to a first embodiment.

FIG. 2 is a perspective view of an optional apparatus according to the first embodiment.

FIG. 3 is a perspective view of a sheet feeding cassette according to the first embodiment.

FIGS. 4A, 4B, and 4C are schematic diagrams illustrating a right housing unit according to the first embodiment.

FIG. 5 is a plan view of a ratchet gear unit according to the first embodiment.

FIGS. 6A, 6B, and 6C are perspective views of a flag and a ratchet output gear according to the first embodiment.

FIGS. 7A and 7B are a plan view and a perspective view of the flag and the ratchet output gear according to the first embodiment.

FIG. 8 is a block diagram illustrating the image forming system according to the first embodiment.

FIGS. 9A and 9B are plan views of a second transmission unit according to the first embodiment.

FIGS. 10A to 10D are plan views of a right housing unit according to the first embodiment.

FIGS. 11A and 11B are perspective views of a conveyance apparatus according to a second embodiment.

FIG. 12 is a plan view of an encoder recording medium according to the second embodiment.

FIGS. 13A and 13B are a plan view and a perspective view around a photosensitive drum according to a third embodiment.

### DESCRIPTION OF THE EMBODIMENTS

Embodiments of the present disclosure will be described in detail below with reference to the attached drawings.

### First Embodiment

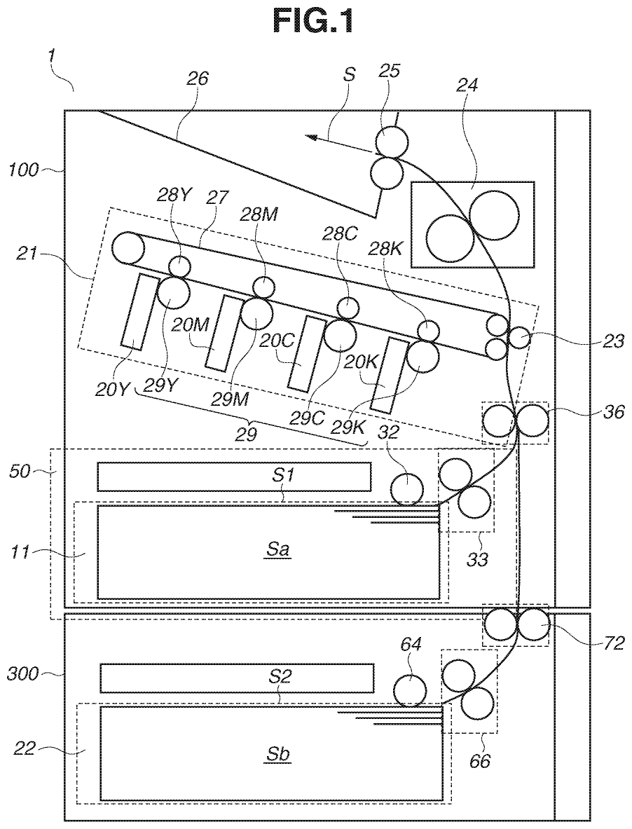

FIG. 1 is a schematic diagram illustrating an image forming system 1 provided with an optional apparatus 300 to which the present disclosure is applied. The image forming system 1 includes an image forming apparatus 100 and the optional apparatus 300. The image forming apparatus 100 is an electrophotographic type color laser printer. According to the present embodiment, an electrophotographic type image forming apparatus is described as an example, but the present disclosure can be applied to an inkjet type printer and the like.

A configuration of the image forming apparatus 100 is described. The image forming apparatus 100 includes a conveyance apparatus 50 that conveys a recording medium. The conveyance apparatus 50 includes a sheet feeding cassette 11, a sheet feeding unit 32, and a separation roller pair 33. The sheet feeding cassette 11 is a storage unit that stores a recording medium. The sheet feeding unit 32 is a pick-up roller that feeds a recording medium S1 located at the top of a recording medium stack Sa loaded in the sheet feeding cassette 11. The separation roller pair 33 separates the recording medium fed by the sheet feeding unit 32 one by one. The image forming apparatus 100 includes a conveyance roller pair 36 that conveys the recording medium separated by the separation roller pair 33.

The image forming apparatus 100 includes an image forming unit 21. The image forming unit 21 includes photosensitive drums 29Y, 29M, 29C, and 29K. In the following description, four colors of yellow, magenta, cyan, and black are respectively represented by Y, M, C, and K, and members having notations Y, M, C, and K indicate those corresponding to the four colors of toner. The image forming unit 21 includes development units 20Y, 20M, 20C, and 20K, primary transfer rollers 28Y, 28M, 28C, and 28K, an intermediate transfer belt 27, and a secondary transfer roller 23. A surface of the photosensitive drum 29 is charged by a charging unit (not illustrated). Next, a scanner irradiates the surface of the photosensitive drum 29 with laser light to form an electrostatic latent image. Next, the electrostatic latent image is developed with toner by the development unit 20 that includes a developer (toner) and a developing roller, and a developer image is formed. The developer image on the surface of the photosensitive drum 29 is primarily transferred onto the intermediate transfer belt 27 by the primary transfer roller 28. Next, the secondary transfer roller 23 transfers the developer image on the intermediate transfer belt 27 to the recording medium fed from the conveyance apparatus 50.

The image forming apparatus 100 includes a fixing unit 24, a sheet discharge roller 25, and a discharge tray 26. The fixing unit 24 applies heat and pressure to a recording medium S on which the developer image is transferred by the secondary transfer roller 23 to fix the developer image onto the recording medium S. The recording medium S on which the toner is fixed by the fixing unit 24 is discharged onto the discharge tray 26 by the sheet discharge roller 25.

The optional apparatus 300 is a storage apparatus that is connected to a bottom part of the image forming apparatus 100 and stores the recording medium. In addition, the optional apparatus 300 is a conveyance apparatus that conveys the recording medium stored therein to the image forming apparatus 100. The optional apparatus 300 includes a sheet feeding cassette 22, a sheet feeding unit 64, a separation roller pair 66, and a conveyance roller pair 72. The sheet feeding cassette 22 is a storage unit that stores the recording medium. The sheet feeding unit 64 is a pickup roller that feeds a recording medium S2 located at the top of a recording medium stack Sb loaded in the sheet feeding cassette 22. The separation roller pair 66 separates the recording medium fed by the sheet feeding unit 64 one by one. The conveyance roller pair 72 conveys the recording medium conveyed by the separation roller pair 66 toward the conveyance roller pair 36.

### (Configuration of Optional Apparatus)

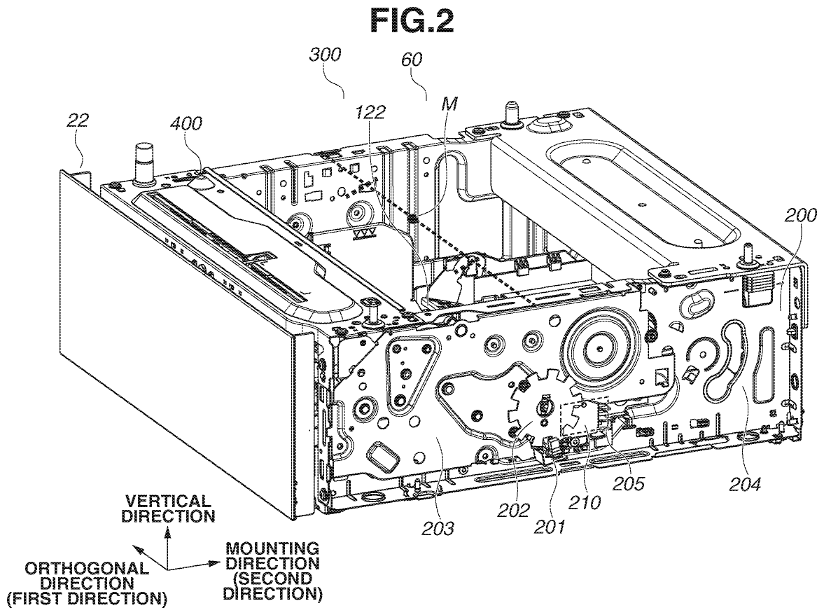

First, a configuration of the optional apparatus 300 is described with reference to FIG. 2. FIG. 2 is a perspective view of the optional apparatus 300. In FIG. 2, some components such as an exterior of the optional apparatus 300 are omitted. Further, a dotted line area in FIG. 2 indicates an area where the motor 205 is disposed. The optional apparatus 300 includes a housing 60 and the sheet feeding cassette 22. The sheet feeding cassette 22 can be pulled out from the housing 60. The sheet feeding cassette 22 can also be mounted to the housing 60. In other words, the sheet feeding cassette 22 is detachably attachable to the housing 60. A direction in which the sheet feeding cassette 22 is mounted to the housing 60 is referred to as a mounting direction.

The sheet feeding cassette 22 includes a recording medium support unit 122 that supports the recording medium. The housing 60 includes a right housing unit 200 and a left housing unit 400. The right housing unit 200 and the left housing unit 400 extend in the mounting direction. The right housing unit 200 is one end of the housing 60 in a direction (orthogonal direction) orthogonal to both the mounting direction and a vertical direction. The left housing unit 400 is the other end opposite to the one end of the housing 60 in the orthogonal direction. In a case where the sheet feeding cassette 22 is mounted to the housing 60, the recording medium support unit 122 is located between the right housing unit 200 and the left housing unit 400 in the orthogonal direction.

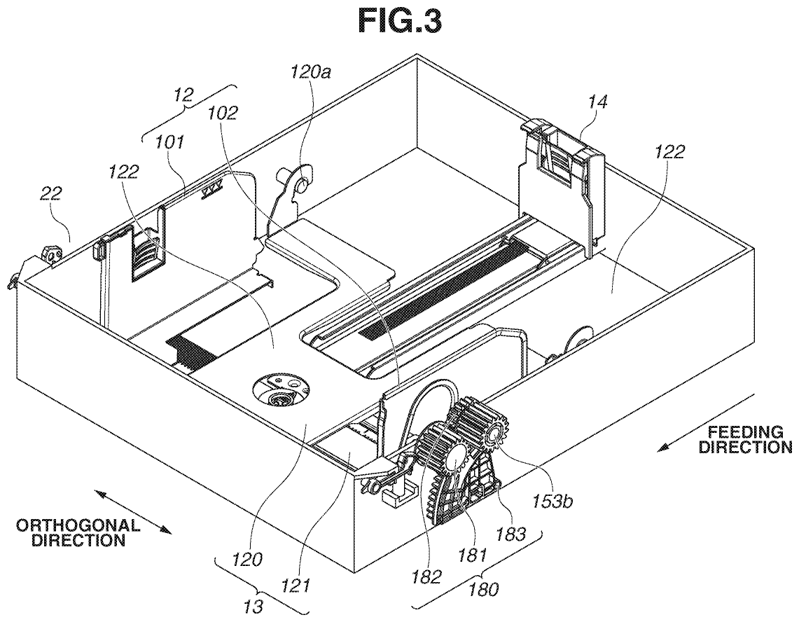

Next, a configuration of the sheet feeding cassette 22 is described with reference to FIG. 3. FIG. 3 is a schematic diagram illustrating the sheet feeding cassette 22. The sheet feeding cassette 22 includes a rear end guide unit 14, a side guide pair 12, a lifter unit 13, and a first transmission unit 180. A direction in which the recording medium is fed to the sheet feeding unit 32 is referred to as a feeding direction. The rear end guide unit 14 is a guide that regulates a position of an upstream end (rear end) of the recording medium in the feeding direction. The side guide pair 12 is a guide that regulates a position of the recording medium in the orthogonal direction, and includes a right guide 102 and a left guide 101.

The lifter unit 13 forms a part of the recording medium support unit 122 that supports the recording medium stack Sa. The lifter unit 13 also serves as a moving unit that lifts the recording medium stack Sa. The lifter unit 13 receives a driving force transmitted from the motor 205, which is described below, and thus rises to a position at which the recording medium can be fed to the sheet feeding unit 32. The lifter unit 13 includes an intermediate plate 120, an arm 121, and a rotation shaft 120a. The intermediate plate 120 is disposed above the arm 121 and is supported by the rotation shaft 120a so as to rotate about the rotation shaft 120a. The arm 121 receives the driving force transmitted from the motor 205 and lifts the intermediate plate 120, and the intermediate plate 120 rotates about the rotation shaft 120a. The rotation shaft 120a extends along the orthogonal direction, and a rotation axis direction of the lifter unit 13 is the orthogonal direction.

Next, the first transmission unit 180 is described. The first transmission unit 180 is a transmission unit that receives a driving force from a second transmission unit 600, which is described below, and transmits it to the arm 121. The first transmission unit 180 includes an interface gear 181, an idler gear 182, and a sector gear 183. The interface gear 181, the idler gear 182, and the sector gear 183 can each be referred to as a transmission unit that transmits the driving force. In other words, the first transmission unit 180 includes a plurality of transmission units that transfer the driving force. The interface gear 181 meshes with a drive output gear 153 of the second transmission unit 600, which is described below. Thus, the interface gear 181 rotates in conjunction with the rotation of the drive output gear 153. The idler gear 182 meshes with the interface gear 181 and rotates in conjunction with the rotation of the interface gear 181. The sector gear 183 meshes with the idler gear 182 and rotates in conjunction with the rotation of the idler gear 182. The arm 121 is connected to the sector gear 183 and rotates in conjunction with the rotation of the sector gear 183. The arm 121 rotates to lift the intermediate plate 120. The rotation axis direction of each of the interface gear 181, the idler gear 182, the sector gear 183, the arm 121, and the intermediate plate 120 is along the orthogonal direction, specifically, the orthogonal direction. (Driving Force Transmission Configuration of Right Housing Unit)

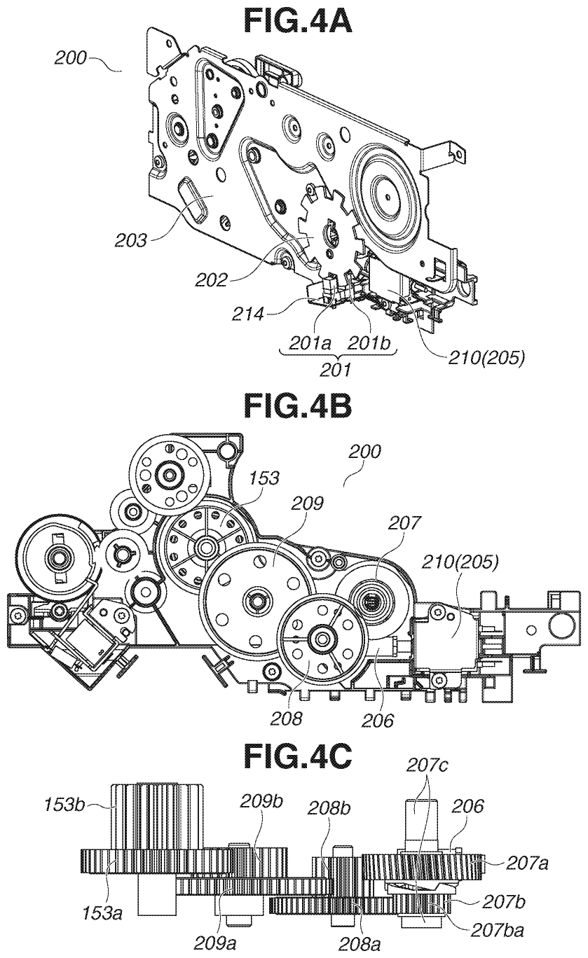

Next, the second transmission unit 600 that is a driving force transmission configuration provided in the right housing unit 200 is described with reference to FIGS. 2, 4A, 4B, and 4C. As described above, the second transmission unit 600 is a transmission unit that transmits a driving force from the motor 205 to the first transmission unit 180. FIGS. 4A, 4B, and 4C illustrate the right housing unit 200. FIG. 4A is a perspective view of the right housing unit 200. FIGS. 4B and 4C are plan views of the right housing unit 200.

The right housing unit 200 includes the motor 205 and the second transmission unit 600. The second transmission unit 600 includes a worm gear 206, a ratchet gear unit 207, a first reduction gear 208, a second reduction gear 209, and the drive output gear 153. The worm gear 206, the ratchet gear unit 207, the first reduction gear 208, the second reduction gear 209, and the drive output gear 153 transmit a driving force and thus can be referred to as transmission units. In other words, the second transmission unit 600 includes a plurality of transmission units that transmit a driving force. As illustrated in FIG. 4C, the worm gear 206, the ratchet gear unit 207, the first reduction gear 208, the second reduction gear 209, and the drive output gear 153 each include a gear and a rotation shaft of the gear. For example, the ratchet gear unit 207 includes a rotation shaft 207c.

The motor 205 is a drive unit that converts electrical energy supplied from a power source (not illustrated) into mechanical energy to generate a driving force. As illustrated in FIG. 4B, the motor 205 includes a shaft 205a that is an output shaft and transmits the driving force. The worm gear 206 is press-fitted to the shaft 205a. Thus, the worm gear 206 rotates in conjunction with the rotation of the shaft 205a. The worm gear 206 meshes with a ratchet input gear 207a, which is on a drive input side of the ratchet gear unit 207. The ratchet input gear 207a and a ratchet output gear 207b are connected via the rotation shaft 207c. The rotation shaft 207c according to the present embodiment is configured by connecting a plurality of components, but may be configured by only one component. The ratchet output gear 207b on the output side of the ratchet gear unit 207 meshes with a large gear 208a provided in the first reduction gear 208. The first reduction gear 208 is provided with a small gear 208b that rotates about the rotation shaft of the large gear 208a and meshes with a large gear 209a provided in the second reduction gear 209. The second reduction gear 209 is provided with a small gear 209b that rotates about the rotation shaft of the large gear 209a and meshes with a large gear 153a provided in the drive output gear 153. In other words, the driving force generated by the motor 205 is transmitted to the worm gear 206, the ratchet gear unit 207, the first reduction gear 208, the second reduction gear 209, and the drive output gear 153 in this order. As described above, the drive output gear 153 meshes with the interface gear 181 and transmits the driving force thereto. More specifically, a small gear 153b provided in the drive output gear 153 meshes with the interface gear 181. In this way, the second transmission unit 600 adjusts a reduction ratio by interposing a plurality of transmission units and increases torque of the drive output gear 153.

### (Drive Configuration of Ratchet Gear Unit)

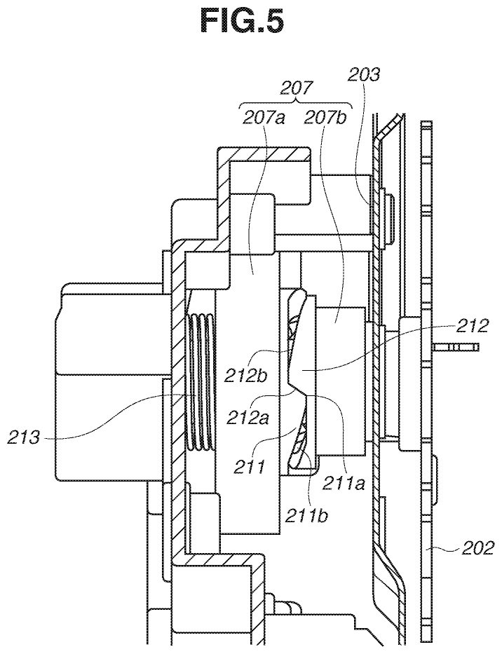

Next, a drive configuration of the ratchet gear unit 207 is described in detail with reference to FIG. 5. FIG. 5 is a cross-sectional view of the ratchet gear unit 207. The ratchet gear unit 207 includes the ratchet input gear 207a, the ratchet output gear 207b, and a biasing spring 213. The biasing spring 213 is a biasing member that biases the ratchet input gear 207a toward the ratchet output gear 207b. Engaging portions 211 and 212 having convex shapes are respectively provided on opposing surfaces of the ratchet input gear 207a and the ratchet output gear 207b. Each engaging portion has inclined surfaces on both sides of the convex shape in the circumferential direction, and connecting surfaces 211a and 212a are surfaces that come into contact when driven by the motor 205. The engaging portions 211 and 212 also include slide surfaces 211b and 212b. The connecting surfaces 211a and 212a and the slide surfaces 211b and 212b have substantially the same inclination. In a normal operation, the ratchet input gear 207a and the ratchet output gear 207b integrally rotate via the biasing spring 213, and transmit the driving force from the motor 205. On the other hand, in a case where an excessive load is applied to the ratchet output gear 207b, the connecting surfaces 211a and 212a ascend the inclined surfaces while coming into contact with each other against the force of the biasing spring 213. When the connecting surfaces 211a and 212a pass over the apex of the convex shape, a holding force in the rotation direction disappears, and the ratchet input gear 207a idly rotates with respect to the ratchet output gear 207b. The ratchet input gear 207a descends the slide surface 212b while being pressed again by the biasing spring 213, stops when the connecting surface 211a comes into contact with the adjacent connecting surface 212a, and returns to a state in which it can transmit the driving force again. In a case where the load continues to be applied, this operation is repeated. In this way, in a case where an unexpectedly large load is generated, the ratchet gear unit 207 serves to prevent damage to the apparatus by not transmitting the driving force.

### (Sheet Number Detection Mechanism)

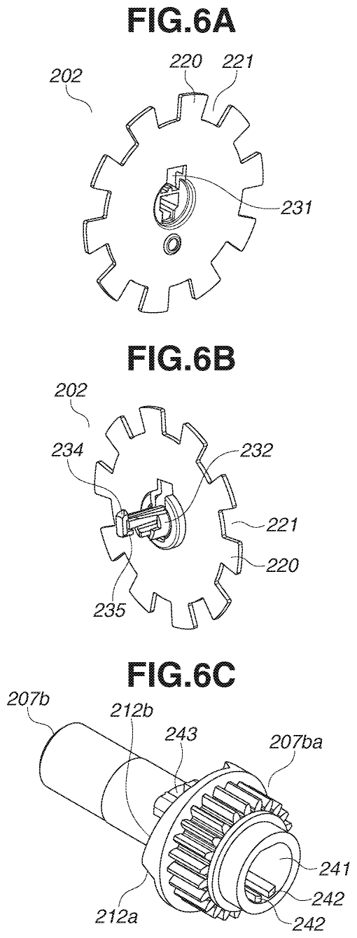

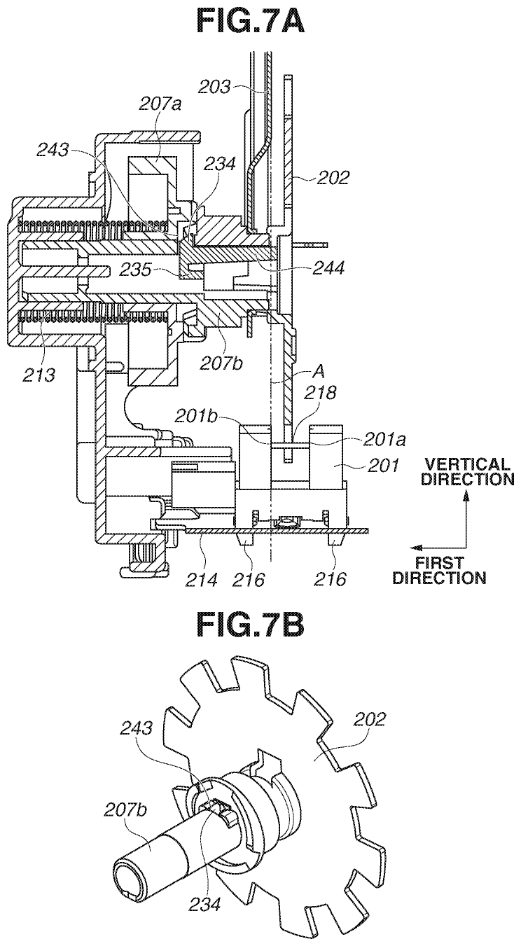

Next, a sheet number detection mechanism that detects the number of recording media supported by the recording medium support unit 122 is described with reference to FIGS. 6A, 6B, 6C, 7A and 7B. The image forming apparatus 100 calculates the number of recording media supported by the recording medium support unit 122, and as a result of calculation, if the number of recording media supported by the recording medium support unit 122 is small, it notifies a user of insufficient recording media. FIGS. 6A and 6B are perspective views of a flag 202 (detected portion), which is described below, as viewed obliquely from the front and rear, respectively. FIG. 6C is a perspective view of the ratchet output gear 207b. FIGS. 7A and 7B each illustrate a state in which the ratchet output gear 207b and the flag 202 are engaged with each other.

First, the engagement between the ratchet output gear 207b and the flag 202 is described. As illustrated in FIG. 2, the right housing unit 200 includes the flag 202. As illustrated in FIGS. 6A and 6B, the flag 202 is an encoder disk. The flag 202 includes a light-shielding portion 220 that blocks light from a light-emitting portion 201a of a sensor 201, which is described below, and a light-transmitting portion 221 that does not block light from the light-emitting portion 201a. Further, the flag 202 includes a rotation stop groove 231, a flag fitting shaft 232, an engagement claw 234, and an engagement claw operating portion 235. On the other hand, as illustrated in FIG. 6C, the ratchet output gear 207b includes an engagement hole 243 and a rotation stop rib 242. A flag fitting hole 241 is formed in the ratchet output gear 207b, and the flag fitting shaft 232 is fitted into the flag fitting hole 241. Further, a side surface of the rotation stop rib 242 and a side surface of the rotation stop groove 231 of the flag 202 are fitted together. The flag 202 is attached to a first side plate 203 from an opposite side of the ratchet gear unit 207. When the flag 202 is inserted into the ratchet output gear 207b, the engagement claw 234 engages with the engagement hole 243. The engagement claw operating portion 235 is a member for releasing the engagement between the engagement claw 234 and the engagement hole 243. A user can release the engagement between the engagement claw 234 and the engagement hole 243 by holding the engagement claw operating portion 235 and pulling down an engaging portion arm 244 inward. As described above, the flag 202 is attached to the ratchet output gear 207b and rotates in conjunction with the rotation of the ratchet output gear 207b. Specifically, the ratchet output gear 207b that receives the driving force from the motor 205 transmits it to the flag 202, and thus the flag 202 rotates. In other words, the flag 202 is connected to the ratchet output gear 207b, and as the ratchet output gear 207b receives the driving force from the motor 205, the flag 202 rotates together with the ratchet output gear 207b. The flag 202 and the ratchet output gear 207b rotate about a common rotational axis.

Here, the ratchet output gear 207b has teeth 207ba. The teeth 207ba are gear teeth that mesh with other gears, and according to the present embodiment, mesh with the large gear 208a provided in the first reduction gear 208.

Next, a configuration of the sensor 201 that detects the rotation of the flag 202 is described. In FIGS. 7A and 7B, the sensor 201 is a photointerrupter that includes the light-emitting portion 201a that emits light 218 and a light-receiving portion 201b that receives the light 218 emitted from the light-emitting portion 201a. The flag 202 rotates so that the light-shielding portion 220 and the light-transmitting portion 221 pass between the light-emitting portion 201a and the light-receiving portion 201b. In a case where the light-shielding portion 220 is located between the light-emitting portion 201a and the light-receiving portion 201b, the light-shielding portion 220 blocks the light 218, so that an amount of light received by the light-receiving portion 201b is reduced. On the other hand, in a case where the light-transmitting portion 221 is located between the light-emitting portion 201a and the light-receiving portion 201b, the amount of light received by the light-receiving portion 201b is not reduced by the light-transmitting portion 221. The sensor 201 alternately detects a light-shielding state and a light-transmitting state based on the amount of light received, and outputs a signal to an optional control unit 48, which is described below.

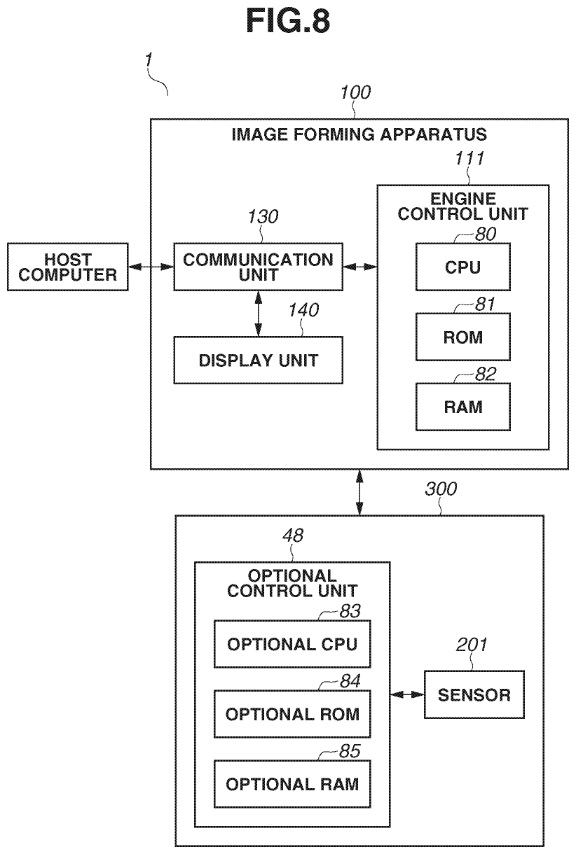

Next, a control configuration of the sheet number detection mechanism is described. First, a control configuration of the image forming system 1 is described with reference to FIG. 8. FIG. 8 is a block diagram illustrating the control configuration of the image forming system 1.

The image forming apparatus 100 includes the engine control unit 111, a communication unit 130, and a display unit 140. The engine control unit 111 includes a central processing unit (CPU) 80, a read-only memory (ROM) 81, and a random access memory (RAM) 82. The communication unit 130 receives a print job from a host computer and communicates with the engine control unit 111 to perform an image forming operation on a recording medium based on the received print job. The display unit 140 is a display that is capable of displaying information. The engine control unit 111 controls the image forming operation. The CPU 80 loads a program and various data to the ROM 81 and executes the program using the RAM 82 as a working area. The ROM 81 is a storage member that stores data. Further, the engine control unit 111 communicates with the optional control unit 48 of the optional apparatus 300 via serial communication that enables bidirectional communication. The optional control unit 48 controls a sheet feeding operation of the optional apparatus 300. The optional control unit 48 includes an optional CPU 83, an optional ROM 84, and an optional RAM 85. The optional ROM 84 is a storage unit that stores data. The optional CPU 83 loads a program and various data to the optional ROM 84 and executes the program using the optional RAM 85 as a working area. Further, the optional control unit 48 receives a signal output by the sensor 201 upon detecting the rotation of the flag 202.

The image forming system 1 determines the number of recording media supported by the sheet feeding cassette 22 (intermediate plate 120) based on the signal output by the sensor 201 upon detecting the rotation of the flag 202. During a period in which the intermediate plate 120 is lifted, the flag 202 rotates together with the ratchet output gear 207b. During the period in which the flag 202 rotates, the light-shielding portion 220 and the light-transmitting portion 221 alternately pass between the light-emitting portion 201a and the light-receiving portion 201b. Accordingly, the signal output by the sensor 201 alternates between ON and OFF, and the optional control unit 48 receives the output signal from the sensor 201. The optional control unit 48 transmits information to the engine control unit 111 based on the received signal. The CPU 80 of the engine control unit 111 counts the number of switching pulses of the signal of the sensor 201 and determines the number of recording media supported by the recording medium support unit 122.

In a case where the number of recording media determined by the CPU 80 is below a predetermined threshold, the communication unit 130 notifies the display unit 140 to display information about the number of recording media. For example, the display unit 140 displays information prompting a user to set/supply the recording medium in the recording medium support unit 122.

### (Positional Relationship of Components)

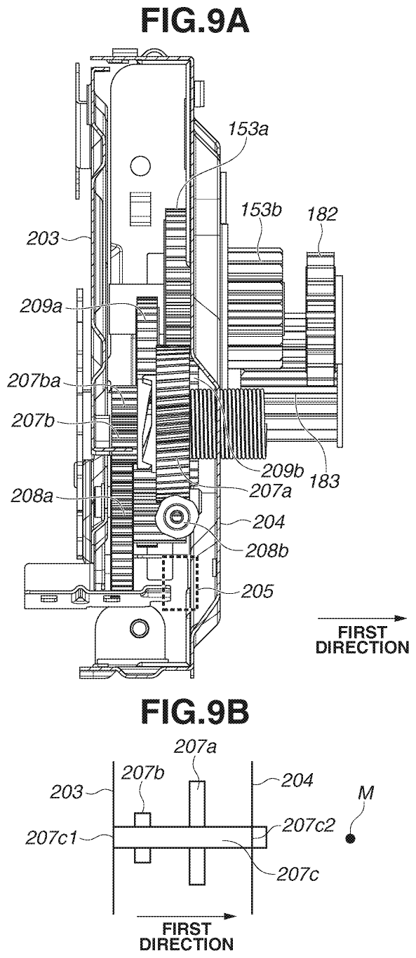

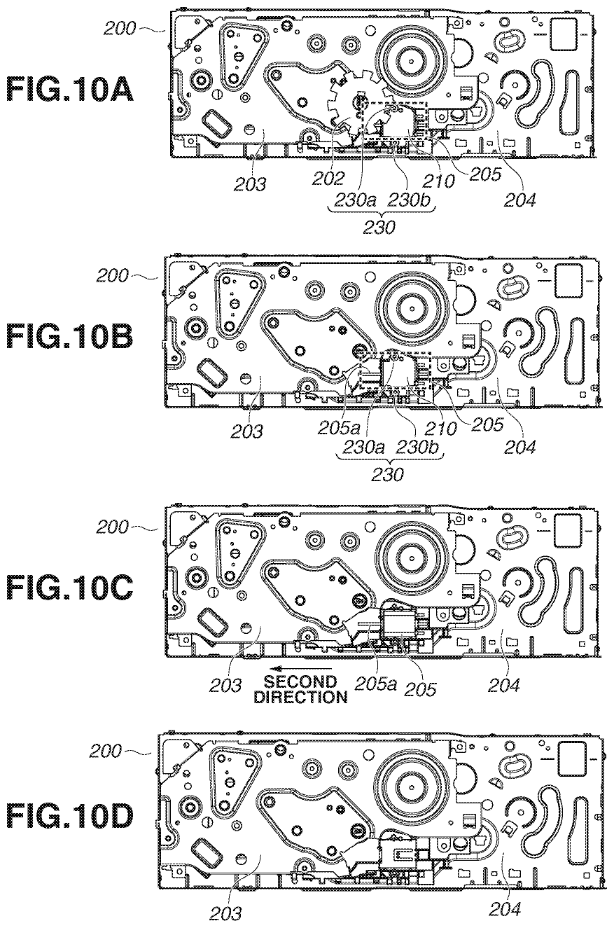

Next, a positional relationship of components according to the present embodiment is described with reference to FIGS. 2, 4A to 4C, 9A, 9B, and 10A to 10D. FIG. 9A is a top view illustrating the second transmission unit 600. FIGS. 10A to 10D are plan views of the right housing unit 200. FIG. 9B is a schematic diagram illustrating the ratchet gear unit 207. Further, a dotted line illustrated in FIG. 9A indicates an area where the motor 205 is disposed.

First, a positional relationship between the first side plate 203 and a second side plate 204 is described. The right housing unit 200 includes the first side plate 203 and the second side plate 204. A longitudinal direction of the first side plate 203 and the second side plate 204 is the mounting direction. In other words, the first side plate 203 and the second side plate 204 extend in the mounting direction. It can also be said that the first side plate 203 and the second side plate 204 extend in a direction intersecting (orthogonal to) the rotation axis direction of the flag 202. Here, the direction of the rotation axis of the flag 202 from the first side plate 203 toward the second side plate 204 is referred to as a first direction. The first direction is also a direction extending from one end 207c1 to another end 207c2, which are described below. The center M illustrated in FIG. 2 indicates the center of the optional apparatus 300 in the orthogonal direction. As illustrated in FIG. 2, the second side plate 204 is disposed inside the optional apparatus 300 (conveyance apparatus) relative to the first side plate 203 in the first direction (the orthogonal direction). In other words, in the first direction, the shortest distance between the second side plate 204 and the center M is shorter than the shortest distance between the first side plate 203 and the center M. It can also be said that the second side plate 204 is downstream of the first side plate 203 in the first direction.

Next, a positional relationship among the first side plate 203, the second side plate 204, and the ratchet gear unit 207 is described. As illustrated in FIG. 9B, the first side plate 203 supports the one end 207c1 of the rotation shaft 207c. Further, the second side plate 204 supports the other end 207c2 opposite to the one end 207c1. In other words, the one end 207c1 of the ratchet gear unit 207 (transmission unit) in the first direction is supported by the first side plate 203, and the other end 207c2 opposite to the one end 207c1 is supported by the second side plate 204. Furthermore, the first side plate 203 and the second side plate 204 each face the ratchet input gear 207a. As illustrated in FIG. 9B, the shortest distance between the one end 207c2 and the center M is shorter than the shortest distance between the other end 207c1 and the center M. As illustrated in FIG. 9A, the teeth 207ba of the ratchet output gear 207b are located between the first side plate 203 and the second side plate 204 in the rotation axis direction (the first direction) of the ratchet output gear 207b.

Next, a positional relationship among the flag 202, the motor 205, the first side plate 203, and the second side plate 204 is described. As illustrated in FIG. 4A, the first side plate 203 is provided with a sensor attachment portion 214 that is arranged to protrude upstream from the first side plate 203 in the first direction. As illustrated in FIGS. 7A and 7B, the sensor 201 is fixed by inserting an attachment portion 216 of the sensor 201 into a hole formed in the sensor attachment portion 214. The light-emitting portion 201a is located outside the flag 202 and the first side plate 203 in the first direction. A long double-short dashed line A illustrated in FIG. 7A is a virtual line indicating a position of a part of a surface of the first side plate 203. In this way, at least a part of the sensor 201 is located outside the first side plate 203 that covers the second transmission unit 600. Similarly, as illustrated in FIG. 2, the flag 202 is located upstream of the first side plate 203 in the first direction. In other words, the first side plate 203 is located between the flag 202 and the second side plate 204 in the first direction. This configuration prevents grease applied to a gear train from scattering onto the sensor 201 and the flag 202 and can reduce false detection and malfunction caused by dirt. Further, since various components, such as the second transmission unit 600, are present inside the first side plate 203, a space for arranging the sensor 201 is small, and the design flexibility is low. Arranging the sensor 201 on the outside of the first side plate 203 increases the design flexibility of the sensor 201. On the other hand, according to the present embodiment, the light-receiving portion 201b is located downstream of the first side plate 203 in the first direction. This configuration can reduce the size of the second transmission unit 600 in the first direction. In other words, by arranging a part of the sensor 201 on the downstream side of the first side plate 203 and another part of the sensor 201 on the upstream side of the first side plate 203 in the first direction, both design flexibility and size reduction can be achieved.

Next, a configuration for arranging the motor 205 is described. As illustrated in FIGS. 4A and 9A, at least a part of the motor 205 is located downstream of the first side plate 203 and the flag 202 in the first direction. In other words, the optional apparatus 300 according to the present embodiment utilizes a space inside the flag 202 as a space for arranging the motor 205. Further, as illustrated in FIGS. 2 and 9A, at least a part of the motor 205 is located upstream of the second side plate 204 in the first direction. In other words, in the first direction, the motor 205 is located between the first side plate 203 and the second side plate 204. FIG. 10C is a plan view illustrating the right housing unit 200 of the motor 205. The rotation axis direction of the shaft 205a extends in a direction intersecting the first direction. For example, the rotation axis direction of the shaft 205a can be referred to as a second direction. The longitudinal direction of the motor 205 is the second direction. In this way, by setting the longitudinal direction of the motor 205 as the second direction, the size of the right housing unit 200 can be reduced.

The right housing unit 200 includes a cover member 210 that covers the motor 205. The cover member 210 is disposed upstream of the motor 205 in the first direction. Further, the cover member 210 is located downstream of the flag 202 in the first direction. In other words, the cover member 210 is located between the motor 205 and the flag 202 in the first direction.

### (Motor Replacement)

Next, a configuration regarding replacement of the motor 205 is described with reference to FIGS. 7A, 7B, and 10A to 10D. FIG. 10A illustrates a state in which the cover member 210 covers the motor 205. FIG. 10B illustrates a state in which the flag 202 is removed from the state in FIG. 10A. FIG. 10C illustrates a state in which the cover member 210 is removed from the state in FIG. 10B. FIG. 10D illustrates a state in which the motor 205 is removed from the state in FIG. 10C. FIGS. 10A to 10D are plan views as viewed in the first direction. Dotted lines illustrated in FIGS. 10A and 10B schematically indicate an area in which the motor 205 exists.

If viewed in the first direction, the flag 202 and the first side plate 203 overlap. Further, if viewed in the first direction, the flag 202 and the motor 205 overlap. A reason why the flag 202 and the motor 205 overlap is described. As the number of transmission units interposed between the motor 205 and the flag 202 increases, the influence of tolerances becomes greater, making it more difficult to accurately detect the rotational speed of the motor 205. Thus, according to the present embodiment, the flag 202 is connected to the ratchet gear unit 207 in order to reduce the number of the transmission units interposed between the motor 205 and the flag 202. Accordingly, the fact that the flag 202 is connected to the ratchet gear unit 207 close to the motor 205 is one of the reasons why the flag 202 and the motor 205 overlap. It can also be said that overlapping the flag 202 and the motor 205 makes it possible to accurately detect the rotational speed of the motor 205. As viewed in the first direction, the cover member 210 overlaps with the motor 205. Further, as viewed in the first direction, the flag 202 overlaps with the cover member 210.

In order to replace the motor 205, first, the flag 202 is removed from the ratchet output gear 207b. As described above, when a user grips the engagement claw operating portion 235 and pulls the engaging portion arm 244 inward, the engagement of the engagement claw 234 is released, and the flag 202 can be removed from the ratchet output gear 207b. Next, the cover member 210 is removed. The cover member 210 is fixed to the right housing unit 200 by inserting screws 230a and 230b into holes formed in the cover member 210. In other words, the screws 230a and 230b can be referred to as fixing members for fixing the cover member 210. As illustrated in FIG. 10B, the fixing member is arranged so as not to overlap with the first side plate 203 as viewed in the first direction. In other words, the fixing member is exposed from the first side plate 203. Accordingly, the first side plate 203 is unlikely to be an obstacle in removing the fixing member, so that the fixing member can be easily removed. The fixing member is removed, and then the cover member 210 is removed. The cover member 210 is arranged so as not to overlap with the first side plate 203 as viewed in the first direction, and thus the cover member 210 can be easily removed. The cover member 210 is removed, and then the motor 205 is removed. In the above-described removal procedure, the flag 202, the cover member 210, and the motor 205 can be removed without removing the first side plate 203, which is not easy to remove from the right housing unit 200.

### Second Embodiment

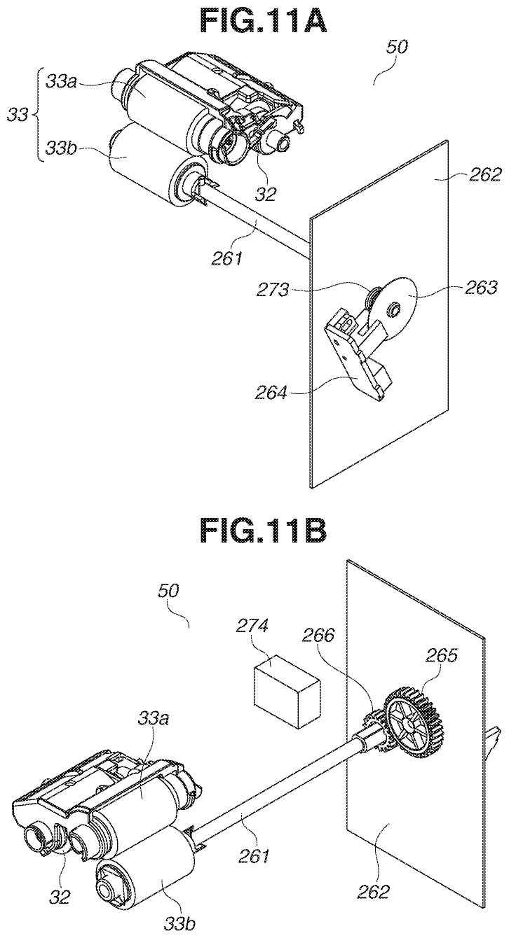

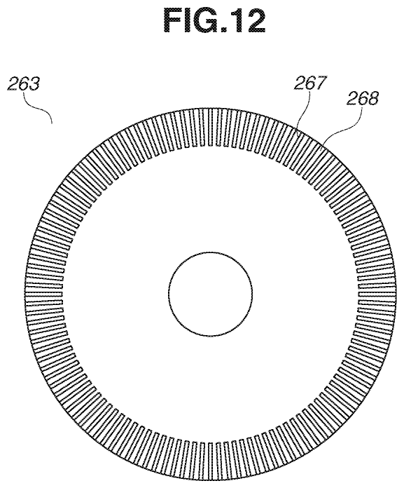

Next, a second embodiment of the present disclosure is described with reference to FIGS. 11A, 11B, and 12. The second embodiment illustrates a case where the present disclosure is applied to the conveyance apparatus 50 of the image forming apparatus 100 according to the first embodiment. The description of the same configuration as in the first embodiment is omitted. FIGS. 11A and 11B are perspective views around the sheet feeding unit 32 according to the second embodiment. FIG. 12 is a plan view of an encoder recording medium 263, which is described below.

The conveyance apparatus 50 includes the separation roller pair 33, a rotation transmission shaft 261, a side plate 262, the encoder recording medium 263, and a rotation detection sensor 264. The separation roller pair 33 includes a separation roller 33a and a separation roller 33b facing the separation roller 33a. Further, the conveyance apparatus 50 includes a motor 274, a rotation detection gear 265, and a rotation transmission gear 266.

The rotation transmission shaft 261 is inserted into a rotation shaft of the separation roller 33b. The rotation transmission gear 266 is attached to another end of the rotation transmission shaft 261. The rotation detection gear 265 meshes with the rotation transmission gear 266. The side plate 262 includes a bearing hole 273 through which the shaft of the rotation detection gear 265 is inserted. The encoder recording medium 263 and the rotation detection sensor 264 are disposed on an opposite side of the side plate 262 from the rotation transmission gear 266. The rotation detection sensor 264 has the same configuration as the sensor 201 according to the first embodiment, and thus a description thereof is omitted.

The encoder recording medium 263 according to the second embodiment is a transparent polyethylene terephthalate (PET) recording medium on which printing is applied to block light from the photointerrupter. As illustrated in FIG. 12, the encoder recording medium 263 includes a band-shaped printed portion 267 and a non-printed portion 268. The printed portion 267 blocks light, and the non-printed portion 268 transmits light. According to the present embodiment, 120 printed portions 267 are evenly printed, but the number of printed portions can be appropriately selected depending on required resolution.

The motor 274 is arranged inside the side plate 262 and transmits a driving force to the separation roller 33a. When the driving force is transmitted to the separation roller 33a, the separation roller 33b is driven to rotate. The rotation of the separation roller 33b is transmitted to the encoder recording medium 263 via the rotation transmission shaft 261, the rotation transmission gear 266, and the rotation detection gear 265. When the encoder recording medium 263 rotates, the printed portion 267 and the non-printed portion 268 alternately block and transmit light, and a pulse signal is generated. The engine control unit 111 calculates a rotational speed of the separation roller 33b from frequency of the generated pulse signal, and controls a timing to stop conveyance drive of the separation roller 33a.

As described above, the motor 274 is located in a space inside the encoder recording medium 263 (detected portion). Accordingly, the image forming apparatus 100 according to the present embodiment utilizes a space inside the encoder recording medium 263 as an arrangement space.

### Third Embodiment

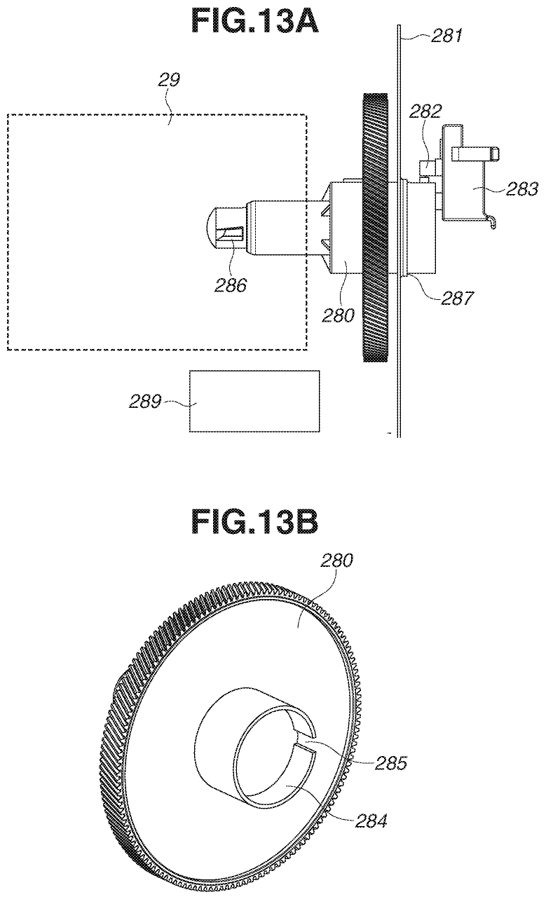

Next, a third embodiment of the present disclosure is described with reference to FIGS. 13A and 13B. The third embodiment illustrates a case where the present disclosure is applied to a drive unit that drives the photosensitive drum 29. FIG. 13A is a plan view around the drive unit of the photosensitive drum 29. Further, FIG. 13B is a perspective view of a part of a drum drive gear 280. The drum drive gear 280 has a drum coupling 286 on one end of the shaft, which engages with a driven coupling (not illustrated) provided inside the photosensitive drum 29 to transmit the driving force. The drum drive side plate 281 has a burring 287 and rotatably supports the shaft on the other end of the drum drive gear 280. A leading edge of the shaft of the drum drive gear 280 protruding from the burring 287 has a cylindrical portion 284. A notch 285 is formed on a part of the cylindrical portion 284. A drum rotation detection sensor 282 is provided on the outside of the drum drive side plate 281, and its detection unit 283 is attached so as to sandwich the cylindrical portion 284. When the notch 285 is present at the detection unit 283 of the drum rotation detection sensor 282, the drum rotation detection sensor 282 is in a non-detecting state.

A motor 289 is provided on the inside of the cylindrical portion 284 and drives the photosensitive drum 29.

When the photosensitive drum 29 drives the drum drive gear 280, the notch 285 rotates with respect to the drum rotation detection sensor 282. When the cylindrical portion 284 reaches the detection unit 283 of the drum rotation detection sensor 282, the drum rotation detection sensor 282 changes to a detecting state. When the drum drive gear 280 rotates once and the notch 285 reaches the detection unit 283 of the drum rotation detection sensor 282 again, the drum rotation detection sensor 282 transitions to the non-detecting state and detects that the drum has rotated once. By repeating this process, the rotation state of the photosensitive drum 29 is grasped and a printing operation is controlled. As described above, the motor 289 is located in a space inside the cylindrical portion 284 (detected portion). The space inside the cylindrical portion 284 is therefore utilized as a space for arranging the motor 289.

According to the present disclosure, a space inside a detected portion can be utilized as a space for arranging a motor.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-052827, filed Mar. 27, 2025, which is hereby incorporated by reference herein in its entirety.

What is claimed is:

1. A conveyance apparatus that conveys a recording medium, the conveyance apparatus comprising:
a motor configured to generate a driving force;
a gear configured to rotate by receiving the driving force;
a first side plate configured to support the gear;
a second side plate that is disposed inside the conveyance apparatus relative to the first side plate in a rotation axis direction of the gear and configured to support the gear;
a detected portion that is connected to the gear and configured to rotate together with the gear; and
a sensor configured to detect rotation of the detected portion,
wherein, in the rotation axis direction, teeth of the gear are located between the first side plate and the second side plate,
wherein, in a case where a direction from the first side plate toward the second side plate in the rotation axis direction is defined as a first direction, the detected portion is located upstream of the first side plate in the first direction, and
wherein at least a part of the motor is located downstream of the detected portion in the first direction.

2. The conveyance apparatus according to claim 1, wherein the motor is located between the first side plate and the second side plate in the first direction.

3. The conveyance apparatus according to claim 1, wherein the detected portion overlaps with the motor as viewed in the first direction.

4. The conveyance apparatus according to claim 3, further comprising a cover member configured to cover the motor,
wherein the cover member is located between the motor and the detected portion in the first direction, and
wherein the cover member overlaps with the detected portion and the motor as viewed in the first direction.

5. The conveyance apparatus according to claim 4, further comprising a fixing member configured to fix the cover member,
wherein the fixing member is arranged at a position not overlapping with the first side plate as viewed in the first direction.

6. The conveyance apparatus according to claim 1,
wherein the motor includes a shaft configured to transmit the driving force,
wherein a rotation axis direction of the shaft is a second direction intersecting the first direction, and
wherein a longitudinal direction of the motor is the second direction.

7. The conveyance apparatus according to claim 1,
wherein the sensor includes a light-emitting portion configured to emit light and a light-receiving portion configured to receive light from the light-emitting portion, and
wherein the detected portion rotates to pass between the light-emitting portion and the light-receiving portion.

8. The conveyance apparatus according to claim 1, wherein the detected portion is an encoder disk.

9. The conveyance apparatus according to claim 1, wherein the conveyance apparatus is connected to an image forming apparatus to convey a recording medium thereto.

10. The conveyance apparatus according to claim 9, further comprising:
a support unit configured to support the recording medium; and
an arm configured to move the support unit by receiving a driving force transmitted from the gear.

11. The conveyance apparatus according to claim 1, further comprising an image forming unit configured to form an image on a recording medium.
